(19) United States
(12) Patent Application Publication
(10) Pub. No.: US 2009/0175196 A1
(43) Pub. Date: Jul. 9, 2009

(54) Process integrated mechanism program, apparatus and method

(76) Inventors: Kenneth M. Ford, Pensacola, FL (US); Niranjan Suri, Pensacola, FL (US)

Correspondence Address: J. Nevin Shaffer, Jr., Suite 43, 913 Gulf Breeze Parkway, Gulf Breeze, FL, 32561, US

(21) Appl. No.: 12/006,535

(22) Filed: Jan. 3, 2008

(51) Int. Cl. H04L 12/28

(52) U.S. Cl. 370/254

(57) ABSTRACT

In a distributed computer system with a number of nodes, a process integrated mechanism includes a coordinating process device for controlling a single node at any instant of time. A run time controller executes the coordinating process device through a transfer cycle where the transfer cycle includes an amount of time the coordinating process device is resident on a single node plus an amount of time required to transfer the coordinating process device between one node and another node such that the coordinating process device is unaware of its movement from one node to another node and such that the total time for the transfer cycle, from the perspective of each node, is fast enough to control each node.

### FIELD OF THE INVENTION

This invention relates to an approach to controlling and coordinating a number of individual nodes, where each node is or contains a computer, that are interconnected via a network, as a single, integrated system, using a single program. In particular, this approach allows such overarching control of the system without requiring that a single node be selected as the master node, thereby not creating a single point of failure or a bottleneck. This approach also does not require nodes to send their information to any other nodes. Instead the approach relies on the notion of moving a single instance of the control program (entitled the coordinating process) rapidly between all the nodes in the system, thereby allowing the coordinating process to directly control each node in the system. Furthermore, this movement is achieved transparently to the control program and the developer or programmer of the overall system, so that the single instance of the control program appears to be controlling every node in the system as if they were all part of the same physical mechanism, with a single computer and the control program is “unaware” of its transfer or movement from one node to another. The invention includes a process integrated mechanism program, apparatus and method for use with a distributed computer system with a number of nodes. In particular, in accordance with one embodiment, the invention relates, in a distributed computer system with a number of nodes, to a process integrated mechanism including a coordinating process device for controlling all of the nodes by controlling a single node at any instant of time. A run time controller executes the coordinating process device through a transfer cycle where the transfer cycle includes residency time, an amount of time said coordinating process device is resident on a single node plus transfer time, an amount of time required to transfer the coordinating process device between one node and another node such that the coordinating process device is unaware of its movement from one node to another node and such that the total time for the transfer cycle, from the perspective of each node, is fast enough to control each node. Moving the coordinating process faster than the reaction time desired by any given node in the system provides the effect of having the coordinating process at every node simultaneously.

### BACKGROUND OF THE INVENTION

Control and coordination of systems consisting of a number of independent nodes interconnected via a network is a very difficult problem. One example of such a problem involves the control and coordination of teams of semi-autonomous robots engaged in complex tasks requiring coordinated action in uncertain and possibly hostile environments to achieve complex and changing goals. In fact, there are presently no satisfactory techniques for reliably coordinating such teams in realistically complex environments. The obvious and traditional approach is to include in the team a single coordinating authority that directs and coordinates the activities of all team members. This approach, however, has difficulties. There is a high communication overhead because the coordinating authority needs to have complete and up-to date information about the operational state of each of the robots. In addition, the overall system is inherently fragile, as any damage to the coordinating authority can render the entire team leaderless. The chief advantage of having a single coordinating authority, however, is simplicity of implementation and predictability of overall team behavior.

Agent-based approaches attempt to address the problems mentioned above. Each robot enjoys “agent-hood” and is responsible for its own actions and maintaining its own world-view. Coordination amongst the agents can require something akin to social negotiation with all its concomitant uncertainties and high computational and communication costs. Partly as a reaction to these problems, biologically inspired approaches attempt to avoid explicit coordination altogether. Under this view, organized behavior must emerge dynamically from the individual actions of “swarms” of simple robots. What all of these approaches lack is a common viewpoint or perspective on the action of the entire team considered as an integrated system, making programming and control of these systems very difficult.

In general prior art systems suffer from one or more of the following weaknesses:
CODE COMPEXITY: Non-centralized approaches to control and coordination of multiple nodes tend to be complex to design and implement, making it difficult and time consuming to develop, test, and debug. Moreover, the complexity of the solution tends to make it difficult to understand and difficult to predict its behavior.
ROBUSTNESS: A key issue is how a system behaves in the face of losing components. In prior art systems that use a single, central node for coordination, failure of that single node will cause the overall system to either fail completely or be seriously degraded in effectiveness.
SIMPLICITY OF COORDINATION: As discussed above, when a collection of robots is conceptualized as a team of independent agents, many complex issues arise concerning how best to communicate and coordinate the activities of the team. In fact, much of the communication required in such systems involves negotiation between the agents. Some of these solutions are also unpredictable in their overall behavior.
EFFECTIVE MANAGEMENT OF DATA: In many of the current prior art systems using modern sensors, the amount of data dwarfs the computational process. As sensors get smarter, they will need to coordinate better to jointly interpret observations. Any truly useful system must excel in simplifying the coordination requirements for large networks of smart sensors and effectively manage data.
DATA SECURITY: Many, if not all, applications deal with the collection and manipulation of sensitive data that must be guarded and cannot be released. In prior art systems, the requirements for data exchange make it difficult to safeguard data that is resident on nodes. Moving the process to the data does not require that the data be transferred off the node where it resides thereby making is easier to guard it.

In summary, prior art systems known to the Applicants require elaborate protocols for communicating between agents, coordinating separate views of the situation or achieving consensus before taking group action. Further, prior art protocols must be written so as to accommodate the architectural complexities of the dynamics of each of the components involved.

Thus, there is need in the art for a system of coordination and communication that, for example only and not by way of limitation, eliminates all point-to-point communication, involves no negotiation protocols and eliminates the need to move large volumes of data. It therefore is an object of this invention to provide a process integrated mechanism program, apparatus and method that does eliminate all point-to-point communication, requires no negotiation protocols and eliminates the need to move large volumes of data while at the same time keeping data secure and enabling direct human involvement in the operation of the mechanism in essentially real time.

### SUMMARY OF THE INVENTION

Accordingly, a process integrated mechanism according to one embodiment includes, in a distributed computer system with nodes, a coordinating process device for controlling a single node at any instant of time. A run time controller executes the coordinating process device through a transfer cycle where the transfer cycle includes residency time, an amount of time the coordinating process device is resident on a single node plus transfer time, an amount of time required to transfer the coordinating process device between one node and another node such that the coordinating process device is unaware of its movement from one node to another and the total time for the transfer cycle, from the perspective of each node, is fast enough to control each node. As used herein, the term “device” includes hardware and software.

Further as used herein, the term “distributed computer system” includes all the ordinary components of a computer system such as, for example only and not by limitation, a CPU, monitor, keyboard, mouse and connections, whether wired or wireless. The CPU includes all the software code and hardware needed to function as is known in the art and not described or disclosed more fully hereafter.

Likewise, the term “node” includes any and all other types of computers, sensors, and remote devices connected with the computer system. For example only and not by way of limitation, a node may be a robotic agent specifically designed to collect particular types of data.

According to another aspect of the invention, when the residency time is increased, the total transfer time is increased but the relative amount of overhead caused by the transfer cycle is decreased. In another aspect, when the residency time is decreased, the relative overhead caused by the transfer cycle is increased but the total transfer time is decreased.

In a further aspect, when a node fails the run time controller skips that node. In another aspect, a copy of the coordinating process device is saved on a node each time the coordinating process device is resident on the node. In one aspect, code that implements the coordinating process device is installed on each node.

In a further aspect, none of the nodes communicate with each other except to discover nodes that are to become part of the transfer cycle, to transfer the coordinating process device, or to recover the coordinating process device. Moreover, the coordinating process device communicates with a node only when resident on that node. In one aspect, the run time controller balances the residency time and the transfer time such that no thrashing occurs.

In a further aspect, the run time controller detects the approach of a thrashing event and increases the residency time. In another aspect, the run time controller detects the need for increased node coordination and temporarily skips some nodes so as to decrease total transfer time.

According to another embodiment of the invention, in a distributed computer system with nodes, computer program code for a process integrated mechanism includes computer code for a coordinating process device for controlling a single node at any instant of time and computer code for a run time controller for executing the coordinating process device through a transfer cycle where the transfer cycle includes an amount of time the coordinating process device is resident on a single node plus an amount of time required to transfer the coordinating process device between one node and another node such that the coordinating process device is unaware of its movement from one node to another and the total time for the transfer cycle, from the perspective of each node, is fast enough to control each node.

According to one aspect of this invention, when the residency time is increased, the total transfer time is increased but the relative amount of overhead caused by the transfer cycle is decreased. In another aspect, when the residency time is decreased, the relative amount of overhead caused by the transfer cycle is increased but the total transfer time is decreased. In another aspect, when a node fails the run time controller skips the node. In another aspect, a copy of the coordinating process device is saved on a node each time the coordinating process device is resident on the node. In another aspect, code that implements the coordinating process device is installed on each of the nodes.

In a further aspect, none of the nodes communicate with each other except to discover nodes that are to become part of the transfer cycle, to transfer the coordinating process device, or to recover the coordinating process device. Moreover, the coordinating process device communicates with a node only when resident on that node. In another aspect, the run time controller balances residency time and transfer time such that no thrashing occurs. In another aspect, the run time controller detects the approach of a thrashing event and increases the residency time. In another aspect, the run time controller detects the need for increased node coordination and temporarily skips some nodes so as to decrease total transfer time.

According to another embodiment of the invention, in a computer system with nodes, a process integrated mechanism method includes: providing a coordinating process device for controlling a single node at any instant of time and a run time controller for executing the coordinating process device through a transfer cycle where the transfer cycle includes an amount of time the coordinating process device is resident on a single node plus an amount of time required to transfer the coordinating process device between one node and another node such that the coordinating process device is unaware of its movement from one node to another and the total time for the transfer cycle, from the perspective of each node, is fast enough to control each node.

According to another aspect of this invention, when the residency time is increased, the total transfer time is increased but the relative amount of transfer overhead caused by the transfer cycle is decreased. In another aspect, when the residency time is decreased, the relative amount of overhead caused by the transfer cycle is increased but the total transfer time is decreased.

In another aspect, when a node fails the run time controller skips that node. In a further aspect, the coordinating process device is saved on a node each time the coordinating process device is resident on that node. In another aspect, code that implements the coordinating process device is installed on each of the nodes. In another aspect, none of the nodes communicate with each other except to discover nodes that are to become part of the transfer cycle, to transfer the coordinating process device, or to recover the coordinating process device. Moreover, the coordinating process device communicates with a node only when resident on that node. In another aspect, the run time controller balances the residency time and the transfer time such that no thrashing occurs. In another aspect, the run time controller detects the approach of a thrashing event and increases said residency time. In a further aspect, the run time controller detects the need for increased node coordination and temporarily skips some nodes so as to decrease total transfer time.

### DESCRIPTION OF THE DRAWINGS

Other objects, features and advantages of the present invention will become more fully apparent from the following detailed description of the preferred embodiment, the appended claims and the accompanying drawings in which:

FIG. 1 is a schematic diagram of the operation of a process integrated mechanism according to one embodiment of the invention; and

FIG. 2 is a flow diagram of the operation of the invention according to FIG. 1.

### DETAILED DESCRIPTION OF THE INVENTION

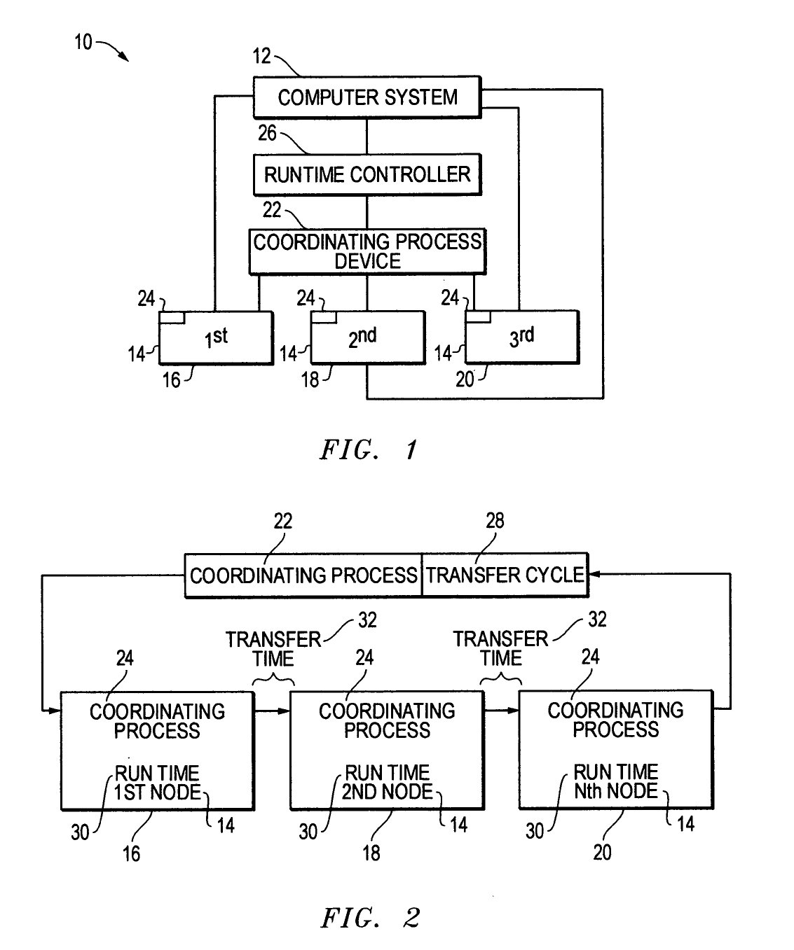

The preferred embodiment of the present invention is illustrated by way of example in FIGS. 1 and 2. With specific reference to FIG. 1, process integrated mechanism 10 includes computer system 12. Preferably, computer system 12 is a “distributed” computer system as that term is known and used in the art. Again, computer system 12 is any computer for accessing, assimilating, and manipulating data now known or hereafter developed. Computer system 12 includes nodes 14. Nodes 14 are interconnected with each other and connected with computer system 12 in any manner, wired or wireless through networks, local and distributed, for example only and not by limitation, now known or hereafter developed. Nodes 14, again for purposes of illustration only and not by limitation, may be computers in the form of autonomous and or semi-autonomous robots. Nodes 14 include a first node 16, a second node 18 and a third node 20 as represented for example only in the figures. The computer system 12 may, of course, include as many or as few nodes 14 as required, desired or useful.

Coordinating process device 22 is provided for controlling the operation of a single node 14 at a time. Coordinating process device 22 may be software, hardware, or a combination. The programming requirements for coordinating process device 22 are well within the ability of those with ordinary skill in the art and will not be described more fully. In fact, as will be discussed hereafter, Applicants invention actually reduces the complexity and simplifies the requirements for coordinating process device 22 as compared to prior art solutions. Importantly, a copy 24 of the code for the coordinating process device 22 is located on each and every node 14 as will be described more fully hereafter.

Run time controller 26 is connected with computer system 12 and coordinating process device 22 for controlling the “movement” of the coordinating process device 22 through a “transfer cycle” as will be described more fully with regard to FIG. 2. As used herein, the term “movement” means the transfer of operational control and activity from one node 14 to another by means of the sequential activation of coordinating process device 22 but not necessarily to actual physical movement.

Run time controller 26 may be software, hardware or a combination. Further, the connection with coordinating process device 22 may be direct, indirect, wired or wireless or any type of connection now known or hereafter developed. As with the coordinating process device 22, the programming skill required is well within the ability of those with ordinary skill in the art.

Referring now to FIG. 2, the operation of process integrated mechanism 10 is more fully explained with regard to the illustrated flow diagram. Again, run time controller 26 (see FIG. 1) controls the movement of coordinating process device 22 through a “transfer cycle” 28. Transfer cycle 28 includes a combination of residency time 30 and transfer time 32. Residency time 30 is the total amount of time coordinating process device 22 is resident and active on a node 14. Transfer time 32 is the total amount of time it takes to transfer the active coordinating process device 22 from one node 14 to another node 14.

One complete transfer cycle 28 includes the amount of residency time 30 that coordinating process device 22 is resident on each node 14 plus the total amount of transfer time 32 required to transfer the coordinating process device 22 between one node 14 and another node 14 for all nodes 14 connected with computer system 12 starting from a specific node 14, such as first node 16, and ending back at that same specific node 14, as for example only first node 16. For the purposes of the present invention, it is important that the total time for one complete transfer cycle 28 is less than an amount of time required for each node 14 to be controlled by and to react to the coordinating process device 22.

Again, copy 24 of coordinating process device 22 is preferably installed on each node 14 in the computer system 12. Certainly it is within the scope of the invention that a copy 24 of coordinating process device 22 is installed on demand instead of being pre-installed. Each node 14 maintains the last run-time state of the coordinating process device 22 after it finished executing on that node 14 and before being moved to the next node 14. However, at any given instant, only one copy 24 on one node 14 is actually running. While it is actually running, copy 24 has complete access to any local data and can directly control any locally performed activity. At some point, this copy 24 is saved on that particular node 14 and the current run time state is transmitted to the next node 14 where the coordinating process device 22 immediately continues to execute and the process is repeated on that particular node 14. Importantly, the time required for this movement of the coordinating process device 22 between nodes 14 is less than the necessary global reaction time of the overall system, providing the illusion that the same process is running everywhere at the same time.

Advantageously, the coordinating process device 22 itself can be programmed under this simplifying assumption: the movement of the coordinating process device 22 is invisible to it (that is, the coordinating process device 22 is “unaware” of any transfers and elapsed transfer time), as well as to an external observer of the system's behavior: it is handled at the run time controller level and can be effectively ignored at all higher levels. It is important to note that although the architecture can be described as parallel and distributed, the coordinating process, coordinating process device 22, itself runs serially and interacts with any other local processes only when it is running on the same platform, node 14, as that process. Thus, the entire process integrated mechanism 10 of the present invention appears to the coordinating process device 22 programmer as a single integrated platform. What seems to be a team of communicating autonomous robots, for example, when seen from the distributed-coordination perspective is actually a single integrated mechanism 10 that can change its distributed shape by moving its parts but has a single locus of control and maintains a single integrated view of its world.

This single coordinating view is a key aspect of the invention which, as a result, requires certain constraints. One constraint is that the invention's own view of the world is identified with the computational state of the coordinating process device 22 so that an update to the coordinating process device 22 is, automatically, an updating of the entire system's worldview. A second constraint is that the updating of this state is the only way that nodes 14 can exchange information with each other. The invention requires that all coordination between components, nodes 14, occurs via changes to information stored in the state of the coordinating process device 22. That is, unlike many of the prior art systems discussed above, none of the nodes 14 talk with each other (except to discover nodes 14 that are to become part of the transfer cycle 28, to transfer the coordinating process device 22, or to recover the coordinating process device 22) and the coordinating process device 22 only talks with a node 14 when the coordinating process device 22 is resident on that particular node 14.

FIG. 2 illustrates this information flow of the invention in the form of a collection of interacting processes on nodes 14 where “vertical interaction” occurs within a local component and “horizontal interaction” is handled by moving the coordinating process device 22. Although the coordinating process device 22 only runs intermittently on any particular node 14, each node 14 of the computer system 12 may support processes that execute purely locally on that node 14, running continuously there. For example, low-level sensory processing that does not require intervention from high-level control is best done locally on a node 14 and local execution controllers can manage local physical effectors. Such “reactive” processes, in fact, may use up the bulk of the processing power on many of the nodes 14 and can run asynchronously with the coordinating process device 22.

It should be noted that most data on node 14 can be maintained locally on the individual node 14 with that data accessible to the coordinating process device 22 only when it is resident on that particular node 14. Further, it should be noted that computation involving that data may still proceed as the coordinating process device 22 is running on another node 14 as long as the necessary information is cached as part of the coordinating process device 22 and moves with the coordinating process device 22 as described above. When the need arises to access data not locally resident or cached, the computation, according to Applicants' invention, must wait until the coordinating process device 22 is again resident on the node 14 where the data is stored.

As mentioned, Applicants have determined that a major advantage of the process integrated mechanism 10 of the present invention is that a programmer of the coordinating process device 22 need not be overly concerned with the system-level details of how the coordinating process device 22 moves between nodes 14. Again, most importantly, the rate at which the coordinating process device 22 moves between nodes 14 must be fast compared to the required reactivity of process integrated mechanism 10. At the preferred proper speed, the transfer cycle 28 is fast enough that all critical coordination decisions for a node 14 can become available in time to appropriately change its behavior.

The Applicants have identified manipulation options in the tradeoffs between computation and coordination involved in the selection of the length of time that the coordinating process device 22 is resident on each node 14. A longer residency time 30 reduces the total fraction of time lost to transfer time 32, thereby increasing the computational efficiency of the process integrated mechanism 10. This increase in computational efficiency, however, comes at the cost of increasing the latency of the coordinating process device 22 as it moves between the nodes 14, thereby decreasing the coordination and reactivity of the process integrated mechanism 10.

Conversely, a shorter residency time 30 enhances the invention's ability to coordinate overall responses to new and unexpected events since the overall transfer cycle 28 will be shorter. However, as residency time 30 is reduced, the ratio of the overhead associated with moving the coordinating process device 22 is increased and thus the computation time available for problem solving is decreased. In extreme cases this could lead to “thrashing” where little computation relevant to coordination is possible because all cycles are being used to move the coordinating process device 22 from one node 14 to another.

This tradeoff can be explicitly monitored and balanced during execution. For example, process integrated mechanism 10 may detect the approach of thrashing and take action to avoid it by, for example, increasing residency time 30. In another situation, when faced with the sudden need for increased coordination, process integrated mechanism 10 may temporarily skip or decommission a node 14 or group of nodes 14, thus decreasing the original transfer time 32 of the coordinating process device 22 amongst the remaining nodes 14 without reducing residency time 30.

By way of further explanation, a key requirement of the invention is that the time of the transfer cycle 28 is small compared to the reaction time needed by the system as a whole. Conditions under which this requirement might fail include situations involving limited bandwidth between components (such as underwater) or where remote communication fails altogether, but these conditions pose significant debilitating difficulties for any distributed system architecture.

By way of comparison, the weaknesses of prior art systems are strengths of the present invention:
CODE COMPEXITY: Any control and coordination system, in order to be truly useful must be as simple as possible and still do the job. As set forth above, process integrated mechanism 10 alleviates these difficulties and greatly simplifies a programmer's task.
ROBUSTNESS: A key issue is how a system behaves in the face of losing components. In prior art systems that use a single, central node for coordination, failure of that single node will cause the overall system to either fail completely or be seriously degraded in effectiveness. In any event, the recovery process may be extremely complex. Furthermore, the increased complexity of the control and coordination algorithm has to be handled by the programmer of the system. Process integrated mechanism 10 in such a case need only re-route around the missing node 14 using conventional network-management technology in order to continue to operate. If a node is destroyed or fails while the coordinating process device 22 is actually resident, the overall system continues to function without significant disruption simply by activating a slightly out-of-date copy 24 of coordinating process device 22 from another node 14.

One of the most significant advantages of the invention is the simplicity of recovering the system after a node fails. This advantage is derived from not allowing communication between the nodes, or between the coordinating process device 22and any other node 14 except the one node 14 on which the coordinating process device 22 is currently executing. If such communication were allowed, the recovery of the system state would be significantly more complicated.
SIMPLICITY OF COORDINATION. As discussed above, when a collection of robots is conceptualized as a team of independent agents, many complex issues arise concerning how best to communicate and coordinate the activities of the team. In fact, much of the communication required in such systems can simply involve negotiation between the agents. All such considerations are rendered irrelevant by Applicants' invention: they appear, if at all, only in the form of conventional issues of data management within a conventional program.
EFFECTIVE MANAGEMENT OF DATA: In many of the current prior art systems using modern sensors, the amount of data dwarfs the size of the computational process. As sensors get smarter, they will need to coordinate better to jointly interpret observations. Any truly useful system must excel in simplifying the coordination requirements for large networks of smart sensors and effectively manage data. In the present invention, the computational process goes to the data rather than moving the data to the computation. This is a huge improvement in any application using modern sensors and greatly simplifies the coordination requirements for large networks of such smart sensors.
DATA SECURITY: Many, if not all, applications deal with the collection and manipulation of sensitive data that must be guarded and cannot be released. In prior art systems, the requirements for data exchange make it difficult to safeguard data that is resident on nodes 14. Applicants' invention allows access to the data but does not require that the actual data be transmitted off-site; and since all transmission of information between processors is within the state of the coordinating process device 22, security issues can be handled by one code stream.

In short, in process integrated mechanism 10, the components are conceived of as parts of a single mechanism, even when they are physically separated and operate asynchronously. Applicants' invention is integrated at the software level rather than by physical connection. It maintains a single unified world-view and behavior is controlled by a single coordinating process device 22. Applicants' invention retains the perspective of a single controlling authority but abandons the prior art notion that this process must have a fixed location within the system. Instead, the computational state of the coordinating process is rapidly moved among the components thereby gaining the advantages of a single controlling process while avoiding the prior art problems with such a system.

By way of continued explanation, one particular general advantage of the present invention is that it does not require elaborate protocols for communicating between nodes 14 or agents coordinating separate views of the situation or for achieving consensus before taking group action. Yet another advantage of the invention is that the actual computer code for the coordinating process device can be largely written in a conventional manner appropriate for a single-processor platform. Taken together, these advantages vastly simplify the top-level coding task, since the programmer does not have to think about how the processing is distributed among the components; and by allowing the use of conventional programming techniques, the overall system behavior is far more predictable than emergent behaviors of other approaches such as multi-agent systems.

On the other hand, the invention enables the idea of a single mechanism comprised of spatially separated parts that are independently mobile thereby creating new opportunities for robotic planning, movement and force coordination and other applications that have heretofore been impractical or realistically impossible. As a result, Applicants' anticipate that the present invention will motivate new developments in programming techniques for advanced robotic control and “adaptive shape” robots, for example only.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. In a distributed computer system with a plurality of nodes, a process integrated mechanism comprising:
a. a coordinating process device for controlling said plurality of nodes by controlling a single node at any instant of time; and
b. a run time controller that executes said coordinating process device through a transfer cycle wherein said transfer cycle includes residency time, an amount of time said coordinating process device is resident on a single node, plus transfer time, an amount of time required to transfer said coordinating process device between one node and another node, such that said coordinating process device is unaware of its movement from one node to another node and such that said total time for said transfer cycle, from the perspective of each node, is fast enough to control each node.

2. The apparatus of claim 1 wherein residency time is increased and transfer time is decreased.

3. The apparatus of claim 1 wherein residency time is decreased and transfer time is increased.

4. The apparatus of claim 1 wherein none of said plurality of said nodes communicate with each other and wherein said coordinating process device communicates with a node only when resident on a node.

5. The apparatus of claim 1 wherein said run time controller detects the need for increased node coordination and temporarily skips some nodes so as to decrease total transfer time.

6. In a distributed computer system with a plurality of nodes, computer program code for a process integrated mechanism comprising:
a. computer code for a coordinating process device for controlling said plurality of nodes by controlling a single node at any instant of time; and
b. computer code for a run time controller that executes said coordinating process device through a transfer cycle wherein said transfer cycle includes residency time, an amount of time said coordinating process device is resident on a single node, plus transfer time, an amount of time required to transfer said coordinating process device between one node and another node, such that said coordinating process device is unaware of its movement from one node to another node and such that said total time for said transfer cycle, from the perspective of each node, is fast enough to control each node.

7. The invention of claim 6 wherein residency time is increased and transfer time is decreased.

8. The invention of claim 6 wherein residency time is decreased and transfer time is increased.

9. The invention of claim 6 wherein none of said plurality of said nodes communicate with each other and wherein said coordinating process device communicates with a node only when resident on a node.

10. The invention of claim 6 wherein said run time controller detects the need for increased node coordination and temporarily skips some nodes so as to decrease total transfer time.

11. In a distributed computer system with a plurality of nodes, a process integrated mechanism method comprising:
a. providing a coordinating process device for controlling said plurality of nodes by controlling a single node at a time and a run time controller that executes said coordinating process device through a transfer cycle wherein said transfer cycle includes residency time, an amount of time said coordinating process device is resident on a single node, plus transfer time, an amount of time required to transfer said coordinating process device between one node and another node, such that said coordinating process device is unaware of its movement from one node to another node and such that said total time for said transfer cycle, from the perspective of each node, is fast enough to control each node;
b. installing said coordinating process device on said plurality of nodes; and
c. running said run time controller through at least one transfer cycle.

12. The method of claim 11 wherein residency time is increased and transfer time is decreased.

13. The method of claim 11 wherein residency time is decreased and transfer time is increased.

14. The method of claim 11 wherein when a node fails said run time controller skips said node.

15. The method of claim 11 wherein a copy of said coordinating process device is saved on a node each time said coordinating process device is resident on said node.

16. The method of claim 11 wherein code that implements said coordinating process device is installed on each of said plurality of nodes.

17. The method of claim 11 wherein none of said plurality of said nodes communicate with each other and wherein said coordinating process device communicates with a node only when resident on a node.

18. The method of claim 11 wherein said run time controller balances said residency time and said transfer time such that no thrashing occurs.

19. The method of claim 11 wherein said run time controller detects the approach of a thrashing event and increases said residency time.

20. The method of claim 11 wherein said run time controller detects the need for increased node coordination and temporarily skips some nodes so as to decrease total transfer time.
